(19) United States
(12) Patent Application Publication
(10) Pub. No.: US 2006/0093750 A1
(43) Pub. Date: May 4, 2006

(54) Method for patterning nano-sized structure

(76) Inventors: Bang Woo Han, Jeonju-si (KR); Jeong Soo Suh, Seoul (KR); Man Soo Choi, Seoul (KR)

Correspondence Address: David A. Einhorn, Esq.;Anderson Kill & Olick, P.C., 1251 Avenue of the Americas, New York, NY, 10020, US

(21) Appl. No.: 10/978,085

(22) Filed: Oct. 28, 2004

(51) Int. Cl. B05D 1/12

(52) U.S. Cl. 427/458; 427/180

(57) ABSTRACT

A nano-sized structure can be accurately patterned while minimizing the generation of a noise pattern by a simple method of electrospraying a nanoparticle dispersion.

### FIELD OF THE INVENTION

The present invention relates to a method for patterning a nano-sized structure by electrospraying a nanoparticle dispersion, which generates no significant noise.

### BACKGROUND OF THE INVENTION

The formation of a micro- or nano-sized structure by way of manipulating nanoparticles to selectively adhere to a pre-designed pattern is termed nanopatterning, which can be advantageously used for the manufacture of quantum devices and opto-electronics.

Such nanopatterning can be conventionally performed by spraying a nanoparticle suspension with a ultrasonic nebulizer and then irradiating with a laser the mist generated by spraying the nanoparticle suspension to guide the nanoparticles to adhere to a pattern formed on a plate. This method, however, is hampered by poor precision and is only suitable for patterning of a structure having a micron size resolution.

Another conventional nanopatterning technique has been reported, which comprises the steps of electrically charging nano-sized particles using a radioactive element such as polonium, and guiding the charged particles to a pattern on a plate endowed with opposite charges using a means such as electronic beams, ion beams, scanning probe microscope tips and metal tips. This method is effective for the patterning of a nano-sized structure, but as the particles are monovalently charged, a significant portion of the nanoparticles adhere to the region beside the formed pattern to generate a noise pattern.

It is known that large particles having the size of micron or more can be made to carry a higher than monovalent charge, but there have been disclosed no reports regarding a method of charging nano-sized nanoparticles to a valence state higher than monovalency. Such multi-valently charged particles would be suitable for patterning a nano-sized structure without generating a noise pattern.

### SUMMARY OF THE INVENTION

Accordingly, it is an object of the present invention to provide an accurate method for patterning a nano-sized structure without generating a noise pattern through the use of multi-valently charged nanoparticles.

In accordance with one aspect of the present invention, there is provided a method for patterning a nano-sized structure, which comprises electrospraying a nanoparticle dispersion through a capillary spray nozzle having a voltage-applying means towards a conductive nano-scale pattern mounted on a grounded plate to guide the migration of the electrosprayed nanoparticle mist thereto, during which the solvent of the mist is vaporized and the charged nanoparticles adhere selectively to the nano-scale pattern.

### BRIEF DESCRIPTION OF THE DRAWINGS

The above and other objects and features of the present invention will become apparent from the following description of the invention, when taken in conjunction with the accompanying drawings, which respectively show:

FIG. 1: A schematic diagram of an exemplary electrospray apparatus that can be used in the inventive nanopatterning process;

FIGS. 2A and 2B: Two embodiments of the inventive process, one by etching a mask layer and the other by transfering electric charge, respectively;

FIG. 3: The electrical mobility distribution of the charged nanoparticles obtained in Example;

FIG. 4: A scanning Electron Microscope (SEM) photograph of the 1000 nm-width line structure obtained in Example; and

FIGS. 5A and 5B: SEM photographs of the 500 nm-diameter dot structures obtained in Example and Comparative Example, respectively.

| | | | |
|---|---|---|---|
| 10: | monitor | 20: | CCD camera |
| 30: | galvanometer | 40: | syringe pump |
| 50: | nanoparticle dispersion | 80: | chamber |
| 60: | voltage-applying means | 90: | capillary spray nozzle |
| 70: | carrier gas inlet | 100: | plate-mounting die |
| 85: | insulating plate | | |
| 95: | carrier gas outlet | | |
| 110: | grounded guide disks having | | |
| | concentric holes | | |
| 115: | charged nanoparticles | | |
| 120: | plate having a pre-designed pattern | | |

### DETAILED DESCRIPTION OF THE INVENTION

The nanopatterning method of the present invention is characterized by the use of nanoparticles having higher than monovalent charges which are generated by electrospraying a nanoparticle dispersion and guided to adhere selectively to a nano-scale pattern.

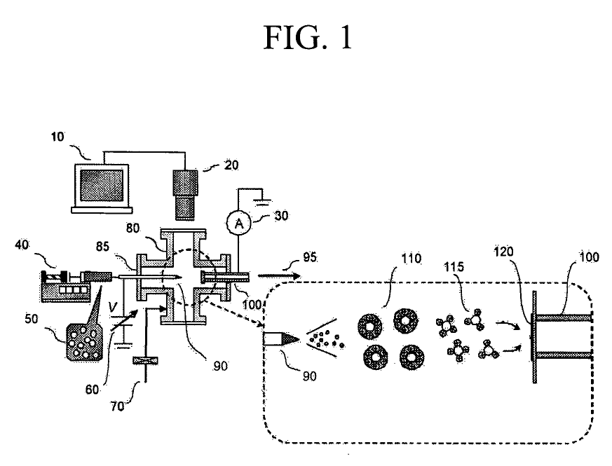

FIG. 1 illustrates a schematic diagram of an exemplary electrospray apparatus that can be used in the nanopatterning in accordance with the present invention. The electrospray apparatus comprises a capillary spray nozzle (90) connected to a syringe pump (40) and a voltage-applying means (60), a plate-mounting die (100) on which a plate having a pre-designed pattern (120) is mounted, and a chamber (80) which encloses the above.

A nanoparticle dispersion (50) is injected into and sprayed out of the spray nozzle (90) by the action of the syringe pump (40). When the nanoparticle dispersion (50) passes through the spray nozzle (90), the nanoparticles become charged with (+) or (−) by manipulating the voltage-applying means (60). It is preferred that nanoparticles of the dispersion have a uniform size. The applied voltage may be in the range of 2 to 20 KV. The injection rate of the dispersion, or the spray rate, may be varied in the range of 5 to 30 μl/hr.

The injected electrosprayed nanoparticle dispersion becomes a uniform ultra-fine mist due to the repulsive force between charged particles. The resulting mist migrates towards a conductive nano-scale pattern mounted on a grounded plate (120) having the polarity opposite to that of the dispersion. During the process, the solvent of the mist is vaporized to generate discrete multi-valently charged nanoparticles (115). If necessary, the solvent may be vaporized by heating. The resulting charged nanoparticles (115) adhere to the pattern region formed on a plate (120) due to the strong static attractive force. A grounded plate having a hole in the center (110) may be placed between the spray nozzle (90) and the grounded plate (120) in order to better guide the particles to the target.

The chamber (80) may be pressimized or maintained under an ambient pressure. In order to enhance the migration of the nanoparticles towards the plate, a carrier gas flow may be introduced in the chamber (80) from a carrier gas inlet (70) positioned nearly the spray nozzle (90) and withdrawn from a carrier gas outlet (95) positioned around the plate-mounting die (100). Nitrogen or carbon dioxide may be used as the carrier gas.

Said conductive nano-scale pattern may be formed on a plate by coating a mask material such as a photoresist on a conductive plate and etching the coating layer to a desired pattern by lithography, or alternatively, by forming a dielectric layer on a plate and transferring electric charge to the region of a pre-designed pattern formed on a dielectric layer.

The photoresist and conductive plate used in the present invention both may be any ones of conventional ones. Representative examples of the photoresist may include polymethylmethacrylate (PMMA), polystyrene (PS) and styrene-butadiene-styrene (SBS). The conductive plate may be of a material such as n-doped and p-doped silicon wafers. Use of an oxygen-, nitrogen- or carbon-containing layer instead of a photoresist layer should be accompanied by a conventional hard mask patterning using a photoresist. After the adherence of nanoparticles to the pattern, the mask coating layer remaining on the plate is generally removed, but in case of the inventive method, the removal of the remaining mask layer can be omitted because of the highly selective adherence of charged particles to the patterned region.

The local transfer of electric charge may be achieved by soft mold stamping using polydimethylsiloxane (PDMS) or scanning probe microscope (SPM) tip contact, the PDMS soft mold stamping being preferred in that the transfer of electric charge can be carried out in a single step. The plate used for the electric charge transfer may be conductive or non-conductive.

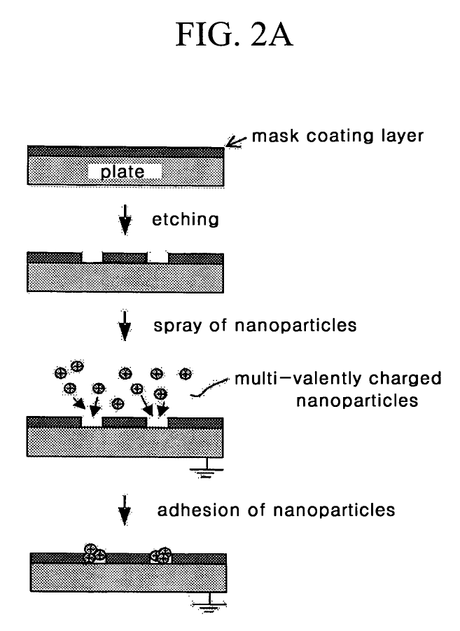

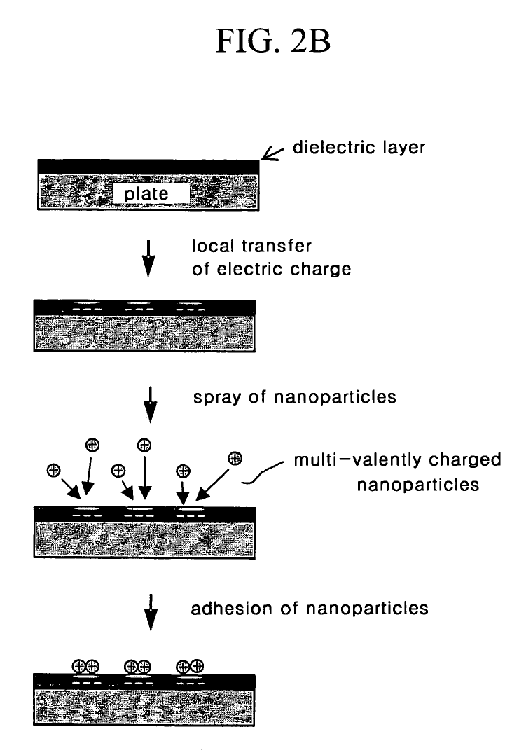

FIG. 2A shows one embodiment of the inventive process to manipulate charged nanoparticles to selectively adhere to the nano-scale pattern region which is formed on a plate by etching a mask coating layer, and FIG. 2B, another embodiment involving the formation of the nano-scale pattern region by local transfer of electric charge.

As described above, the present invention provides for the first time a simple and accurate method for patterning a nano-sized structure without generating a significant noise pattern through the use of multi-valently charged nanoparticles.

The following Example and Comparative Example are given for the purpose of illustration only, and are not intended to limit the scope of the invention.

### EXAMPLE

The patterning of a nano-sized structure in accordance with the present invention was performed using the apparatus shown in FIG. 1. The capillary spray nozzle (90) was made of a stainless steel pipe having an outer diameter of 0.23 mm and an inner diameter of 0.1 mm. The plate-mounting die (100) was placed at a distance of 30 mm from the spray nozzle (90). The grounded plate (110) having a hole in the center was placed at a distance of 10 mm from the spray nozzle (90) on the straight path between the spray nozzle (90) and plate-mounting die (100). Used as a nanoparticle dispersion (50) was a 50:50 mixture of methanol and a commercially available colloidal solution of 20 nm-sized Ag nanoparticles (G1652, Gold Colloid, Sigma Aldrich, Chemie Gmbh).

First, a conductive nano-scale pattern having a line resolution of 100 to 10000 nm was formed on a silicon wafer plate by exposing a photoresist coating layer to electronic beam-lithograph and removing the exposed region. The patterned plate (120) was installed on the plate-mounting die (100) such that the pattern faced the spray nozzle (90), and it was grounded. The chamber (80) was maintained at room temperature under an ambient pressure. The chamber interior was observed through the monitor (10) and CCD camera (20).

Then, the nanoparticle dispersion (50) was injected into the spray nozzle (90) to be sprayed at a rate of 5 μl/hr, while applying a voltage of 3 to 4 KV thereon. In the chamber (80), a nitrogen carrier gas was allowed to flow at a rate of 2 slm (standard liter per minute). The electrosprayed nanoparticle mists were guided to the plate. The solvent was vaporized during the process, and the charged nanoparticles attached selectively to the etched region of the plate to form a nano-sized structure.

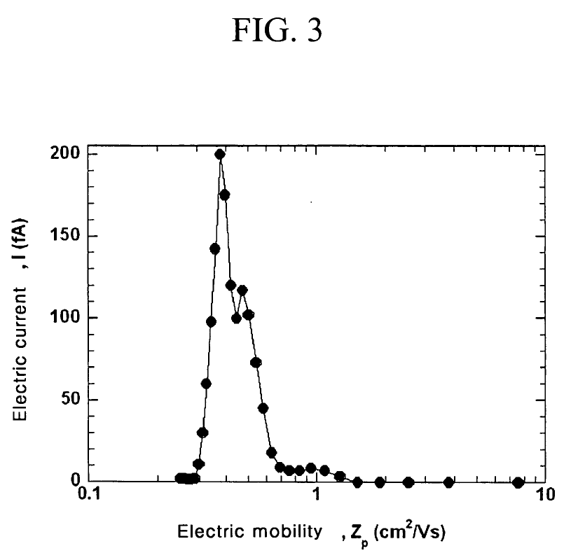

The electrical mobility distribution of the charged nanoparticles is measured by using a differential mobility analyzer and a Faradaycup electrometer, and the result is shown in FIG. 3. In FIG. 3, peaks are detected at around 0.4 and 0.9 cm²/Vs, suggesting that the 20 nm-sized nanoparticles had an average charge valence in the range of 100 to 126.

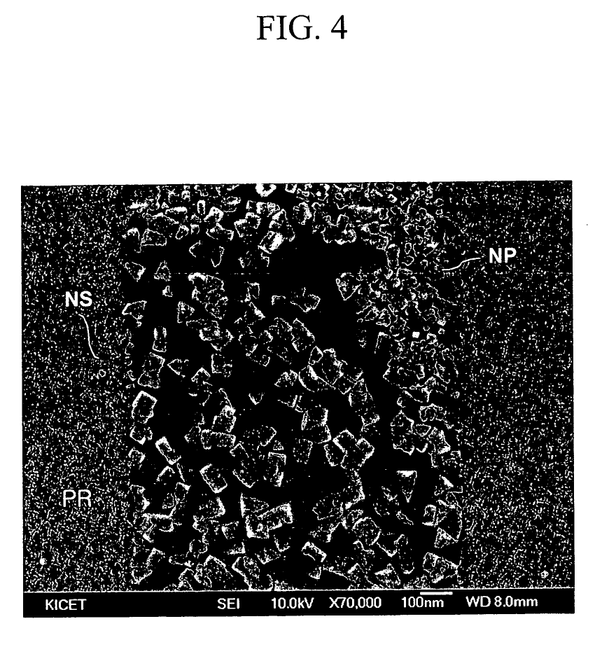

An SEM photograph of the resultant 1000 nm-width line structure shown in FIG. 4 suggests that the nanoparticles selectively adhered only to the pattern (NP), generating no significant noise pattern (NS).

### COMPARATIVE EXAMPLE

Ag nanoparticles were generated by a conventional evaporation and condensation method, electrified using radioactive 210-polonium, and subjected to a differential mobility analyzer, to obtain 20 nm-sized monovalent Ag nanoparticles. The monovalent Ag nanoparticles were guided to adhere to a nano-scale pattern prepared as in Example by a conventional evaporation-condensation method.

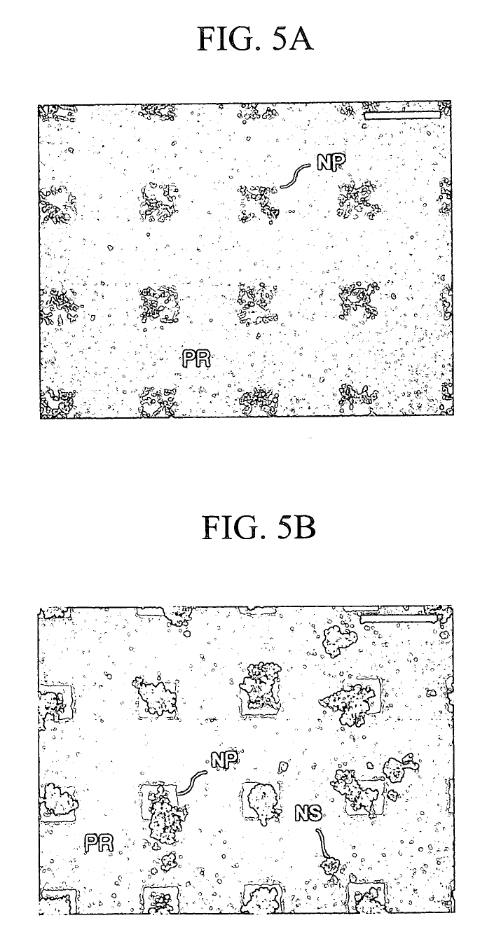

SEM photographs of the resultant 500 nm-diameter dot structures obtained in Example and Comparative Example are shown in FIGS. 5A and 5B, respectively. As can be seen in FIGS. 5A and 5B, in case of Comparative Example, a large number of the nanoparticles are attached to the region outside the pattern (PR), generating a significant noise pattern (NS), while in Example, almost all of the nanoparticles are attached only to the pattern (NP). These results demonstrate that the inventive method does not require the process of removing the residual photoresist layer, unlike the conventional method.

As described above, in accordance with the method of the present invention, a nano-sized structure may be simply and accurately patterned while minimizing the generation of a noise pattern.

While the invention has been described with respect to the above specific embodiments, it should be recognized that various modifications and changes may be made to the invention by those skilled in the art which also fall within the scope of the invention as defined by the appended claims.

What is claimed is:

1. A method for patterning a nano-sized structure, which comprises electrospraying a nanoparticle dispersion through a capillary spray nozzle having a voltage-applying means towards a conductive nano-scale pattern mounted on a grounded plate to guide the migration of the electrosprayed nanoparticle mist thereto, during which the solvent of the mist is vaporized and the charged nanoparticles adhere selectively to the nano-scale pattern.

2. The method of claim 1, wherein the conductive nano-scale pattern is formed on the plate by etching of a mask coating layer, or by transfer of electric charge.

3. The method of claim 2, wherein the nano-scale pattern is formed by etching on a conductive plate.

4. The method of claim 2, wherein the mask material is a photoresist.

5. The method of claim 2, wherein the transfer of electric charge is performed by soft mold stamping using polydimethylsiloxane.

6. The method of claim 1, wherein a voltage ranging from 2 to 20 KV is applied to the nanoparticle dispersion.

7. The method of claim 1, wherein the nanoparticle dispersion is sprayed at a rate ranging from 5 to 30 μl/r.
